(19) United States
(12) Patent Application Publication
(10) Pub. No.: US 2009/0132363 A1
(43) Pub. Date: May 21, 2009

(54) PROCESS ENABLEMENT AND OPTIMIZATION SYSTEM FOR WEB ADVERTISING PLACEMENT AND PRICING

(76) Inventors: Andrew Powell, Indio, CA (US); Leo Corley Singleton, IV, Fort Lauderdale, FL (US)

Correspondence Address: ATTN: E.J. ASBURY III;TAYLOR BUSCH, LLP, 1600 PARKWOOD CIRCLE, SUITE 200, ATLANTA, GA, 30339, US

(21) Appl. No.: 11/948,995

(22) Filed: Nov. 30, 2007

Related U.S. Application Data
(60) Provisional application No. 60/868,044, filed on Nov. 30, 2006.

(51) Int. Cl. G06Q 30/00

(52) U.S. Cl. 705/14

(57) ABSTRACT

The present invention provides an enablement and optimization system and method for web advertisement placement and pricing. The invention provides an open advertising network that incorporates both the advertisers and content publishers into the advertising decision process to create an open marketplace. Similar to a greedy algorithm in Computer Science, this model pushes the final advertising decision to the web servers that serve the actual content. Rather than an advertising network providing a single ad to show, the content publisher receives a selection of ads. Each publisher in the network then makes the local optimum choice by collecting data on the effectiveness of ads previously shown, and using this data to select which ad will perform the best. Similarly, the advertisers collect data on the visitors they receive from advertising, and use this information to optimize their bidding. With each endpoint selecting a local optimum, the network of advertisers and content publishers as a whole becomes more effective.

### CROSS-REFERENCE TO RELATED APPLICATION

This application claims the benefit of U.S. Provisional Application Ser. No. 60/868,044 filed on Nov. 30, 2006, which is hereby incorporated herein by reference.

### BACKGROUND OF THE INVENTION

1. Field of the Invention

The present invention generally relates to an enablement and optimization system and method for web advertising. More particularly, the present invention relates to a system and method where web publishers and advertisers can continually optimize ad cost and placement to yield the best possible result for all parties involved, and to provide for the seamless delivery of advertisements inline with a publisher's main web page content.

2. Description of the Related Art Internet advertising is a rapidly growing industry that is maturing very rapidly. The industry originated from simple link exchanges in the mid-1990s, progressed to run-of-site CPM banner campaigns, and has recently become incredibly complex. Furthermore, advertisers can now target their messages and track performance with impressive accuracy.

The current advertising networks use two primary pricing models: Cost Per Mile (CPM) and Cost Per Click-Through (CPC). The CPM metric comes from print advertising, and is the cost for 1,000 impressions, or showings of an ad. Initially, Internet advertising networks offered only CPM pricing, but CPC pricing offers advertisers a guaranteed amount of traffic to their web site for a given cost, and thus has become very popular. Google offers CPC pricing which allows advertisers to bid on individual keywords-keyword pricing can range from as little as 1 cent per click to as much as $100 per click.

Keyword-targeted advertisements have altered the landscape of online advertising. These advertisements have dramatically increased the value of Internet ads to advertisers, because it allows them to target their ads to a specific audience.

While keyword-targeted advertising has allowed advertisers to have some control of the ad placement logic, content publishers cede much of their control to centralized advertising networks. The advertising network decides which keywords or topics to assign to a particular publisher site and then places ads based on its own proprietary algorithms. Content publishers must assign space on their site to one particular advertising network, and show the ads chosen by that network. This can frequently lead to non-optimal ad placement.

In some cases, the keyword-targeting algorithms may focus on a few words that do no relate to the main content of the site—this results in poor ad targeting, and thus poor revenues for all parties. In other cases, the advertising network may place low-priced or poorly performing ads, which do not generate enough revenue or cause large fluctuations in revenue for the content publisher.

Furthermore, existing networks serve ads to visitors via a third party. Some common methods of serving ads via third parties involve the use of external JavaScript or content called via an <IFRAME>. Because most advertising networks rely on these third party methods for tracking and verification, it is generally not practical to allow the publisher to serve the ad inline with the normal web site content. However, there are many benefits to overcoming this challenge. Third party scripts and <IFRAME> tags can cause ads to load slowly, to be poorly integrated into the visual layout of a site, to be filtered by the visitor's ISP (Internet Service Provider), or to be filtered by the visitor's web browser. Regardless, this can cause ads to be ignored by visitors. Allowing the publisher to seamlessly serve the advertisement with the content can alleviate these issues.

The existing ad placement systems either do not provide the information, the tools, or the interface for publishers and advertisers to engage in continuous optimization. It is readily apparent there is a need in the art for improvement. Accordingly, it would be advantageous to provide a system which incorporates both the advertisers and content publishers into the advertising decision process and creates an open marketplace. When equipped with the right information, web publishers and advertisers can continually optimize ad cost and placement to yield the best possible result for all parties involved. Furthermore, such a system could provide for the seamless delivery of advertisements inline with a publisher's main web page content. It is thus to such an enablement and optimization system and method for web advertising placement and pricing that the present invention is primarily directed.

### SUMMARY OF THE INVENTION

The disadvantages of the prior art are overcome by the present invention which, in one aspect, is a web advertising system. The system being configured to provide an online advertisement data exchange between advertisers, publishers, and web users. The web advertising system includes a web server configured to provide a user interface to advertisers and publishers accessing the online advertisement information exchange, one or more application servers, in communication with the web server, and configured to manage data objects associated with the respective advertisers and publishers, and a database in communication with the one or more application servers, the database storing data including the data objects.

The data objects include a plurality of advertiser accounts, a plurality of publisher accounts, a plurality of ads supplied by the plurality of advertisers, with each ad comprising at least one ad bid, at least one publisher website, and an ad budget. The application servers are configured to periodically calculate a bidding matrix and a throttling matrix for the plurality of ads and publishers. The web server is further configured to allow a publisher to periodically access and download the plurality of ads, a portion of the bidding matrix relative to the publisher, and a portion of the throttling matrix relative to the publisher. The application servers is further configured to receive a web user selection of a particular ad from a publisher website, storing the data regarding the user selection, the associated ad, and the associated publisher website, and redirecting the user to an advertiser website associated with the relevant advertiser and ad.

In another aspect of the present invention, the application servers of the web advertising system are configured to use the data regarding the user selection, the ad, and the publisher. The application servers access the data comprising the ad budget, the bidding matrix relative to the publisher, and the throttling matrix relative to the publisher. The servers verify the ad bid corresponding to the ad and publisher within the bidding matrix, and verify the availability for user selection corresponding to the ad and publisher within the throttling matrix. Finally, the application servers store a verification result.

In another aspect of the present invention, within the web advertising system the stored verification results are used in the next periodic calculation of the throttling matrix. Based upon the verification results, web advertising system subtracts the ad bid from the ad budget of the advertisers account. Based upon the verification results, the publishers account is credited with the ad bid. The web advertising system may also include an accounting package in communication with the database. The accounting package configured to manage billing among the advertisers and payment among the publishers.

In yet another aspect of the present invention, the web server is configured to allow a publisher to periodically accesses and download the plurality of ads, a portion of the bidding matrix relative to the publisher, and a portion of the throttling matrix relative to the publisher. The publisher then evaluates the profitability of each potential ad using the ad bid, and using an estimate of the rate of user selections. The publisher then selects a subset of the plurality of ads for display on the publishers' websites, and publishes the selected ads on the publishers' websites. The publisher serves the selected ads inline with other content on the publishers website.

In yet another aspect of the present invention, the publishers' estimate of the rate of user selections is based on at least one of, a trial estimate, the prior display of the same ad, the prior display of similar ads, or the prior display of ads from the same advertiser.

In yet another aspect of the present invention, within the web advertising system, each ad as supplied by an advertiser comprises at least one of, a default ad bid for all publisher websites, a unique ad bid for each publisher website, a unique ad bid for each advertising category of websites, or an ad bid of $0.0 for a publisher website.

In yet another aspect of the present invention, the web server is configured to allow an advertiser to periodically accesses and download the data associated with the advertiser account regarding the user selections, the associated ad, and the associated publisher website. The advertiser then evaluates the effectiveness of each ad, using the ad bid, the rate of user selections, and the rate of sales generated per user selection. The advertiser then updates the ad bids for each publisher website, and the ad budget, and then uploads to the web server the updated ad bids for each publisher website, and the ad budget. The updated ad bids for each publisher are then used in the next periodic calculation of the throttling matrix.

In yet another aspect of the present invention, the application servers calculate the bidding matrix, and the throttling matrix, for the plurality of ads and publishers within the system at periodic intervals.

In yet another aspect, the present invention provides a method of enabling and optimizing web advertisement placement and pricing. The method including receiving on a web server a plurality of advertiser accounts, a plurality of ads supplied by the plurality of advertisers, each ad comprising at least one ad bid, at least one publisher website, and an ad budget, and a plurality of publisher accounts. Storing the plurality of advertiser accounts, advertisements, and publisher accounts in a database. Periodically calculating on an application server a bidding matrix and a throttling matrix for the plurality of ads and publishers, the application server, web server, and database being interconnected. A publisher periodically accessing and downloading the plurality of ads, a portion of the bidding matrix relative to the publisher, and a portion of the throttling matrix relative to the publisher. The application servers receiving a web user selection of a particular ad from a publisher website. The servers then storing the data regarding the user selection, the associated ad, and the associated publisher website in the database. And finally, redirecting the user to an advertiser website associated with the relevant advertiser and ad.

In yet another aspect, using the data regarding the user selection, the associated ad, and the associated publisher the system accesses the data comprising the ad budget, the bidding matrix relative to the publisher, and the throttling matrix relative to the publisher. Verifies the ad bid corresponding to the ad and publisher within the bidding matrix. Verifies the availability for user selection corresponding to the ad and publisher within the throttling matrix. And finally stores a verification result in the database.

These and other aspects of the invention will become apparent from the following description of the preferred embodiments taken in conjunction with the following drawings. As would be obvious to one skilled in the art, many variations and modifications of the system and steps of the method may be effected without departing from the spirit and scope of the novel concepts of the disclosure.

### BRIEF DESCRIPTION OF THE DRAWINGS

FIG. 1 is an illustration of the prior art system of web advertising.

FIG. 2 is an illustration of the system of web advertising placement and pricing as enabled by the present invention.

FIG. 3 is an overview of the system of web advertising placement and pricing as enabled by the present invention.

FIGS. 4-8 are illustrations of the steps of the web advertising process as enabled by the present invention.

FIGS. 9-11 are illustrations of possible advertiser interactions with the system.

FIGS. 12-15 are illustrations of possible publisher interactions with the system.

FIG. 16 is an illustration of the bidding matrix of the system.

FIG. 17 is an illustration of the throttling matrix of the system.

### DETAILED DESCRIPTION OF THE INVENTION

The present invention provides an enablement and optimization system and method for web advertisement placement and pricing. The present invention provides an open advertising network that incorporates both the advertisers and content publishers into the advertising decision process to create an open marketplace. Similar to a greedy algorithm in Computer Science, this model pushes the final advertising decision to the web servers that serve the actual content. Rather than an advertising network providing a single ad to show, the content publisher receives a selection of ads. Each publisher in the network then makes the local optimum choice by collecting data on the effectiveness of ads previously shown, and using this data to select which ad will perform the best. Similarly, the advertisers collect data on the visitors they receive from advertising, and use this information to optimize their bidding. With each endpoint selecting a local optimum, the network of advertisers and content publishers as a whole becomes more effective.

Within the system, the parties in the process, i.e. the publishers and advertisers, work to maximize their own benefit. By allowing each party to work for their own benefit, the system trends towards a global optimum i.e. advertisers realize a high Return on Investment (“ROI”) while publishers earn high revenue. When equipped with the right information, web publishers and advertisers can continually optimize ad cost and placement to yield the best possible result for all parties involved. The system supplies each party with relevant data, and supplies each party with a means to participate as an advertiser or publisher.

Unlike existing advertising networks, which use proprietary targeting algorithms, the system allows advertisers fine-grained bidding for advertising space and passes all applicable advertisements and bids to the publishers, who then select ads for their web sites. This allows both the advertisers and content publishers to choose their own ad placement metrics, while the system provides the marketplace.

It is up to each advertiser and publisher to select or develop an algorithm that maximized the party's profitability. In the advertising market, it is ultimately up to each publisher and advertiser to determine how they measure profitability. In practice, of course, publishers and advertisers will normally attempt to select the most monetarily profitable ads—but they may use other criteria, including non-monetary criteria, such as new market penetration, to help determine profitability.

The system and method utilize a computer program running on a computer processor. The processor has a central processing unit, random access memory, read only memory, various data and communication busses, and electronic input/output means as are well known to those skilled in the art. The computer processor may be a single unit, or may be an electronically interconnected system of processors. The computer processor may be in the form of a web server, and one or more application servers. The computer program to enable the present invention may be coded in any convenient programming language such as Java, PHP, or other language as are readily known to those skilled in the art.

The data associated with the system and method is stored as data object in a database on a data storage device. The data storage may be integral with the processing unit, or may be at a remote location and electronically interconnected to the processing unit. The data stored in the device will include the multiple advertiser accounts, multiple publisher accounts, and ads supplied advertisers. Each ad supplied by the advertisers will include the actual ad content, bid amounts corresponding to publisher web sites, and a total ad budget. The data stored in the storage device will also include a calculated bidding and throttling matrices, ad performance data from the publishers, and accounting data for the publishers and advertisers.

In one embodiment of the present invention, the electronic connection between the components of the advertising enablement and optimization system, such as between the processor, the data storage device, and the participants, the advertisers, the publishers of web content, and users, occurs over a global computer network, otherwise known as the internet or web. The participant access and interaction with the system is via a common web browser such as Internet Explorer®, or via other web browser applications as are readily known to those skilled in the art. In alternative embodiments of the present invention, some components of the system may be connected via a local intranet, via a dedicated hardwire, or via other computer interconnect means as are readily known to those skilled the arts. In other alternative embodiments of the present invention, participants in the process may access the system via an intranet, via phone, via a direct hardwire connection to the processor or via other computer access means as are readily known to those skilled the art.

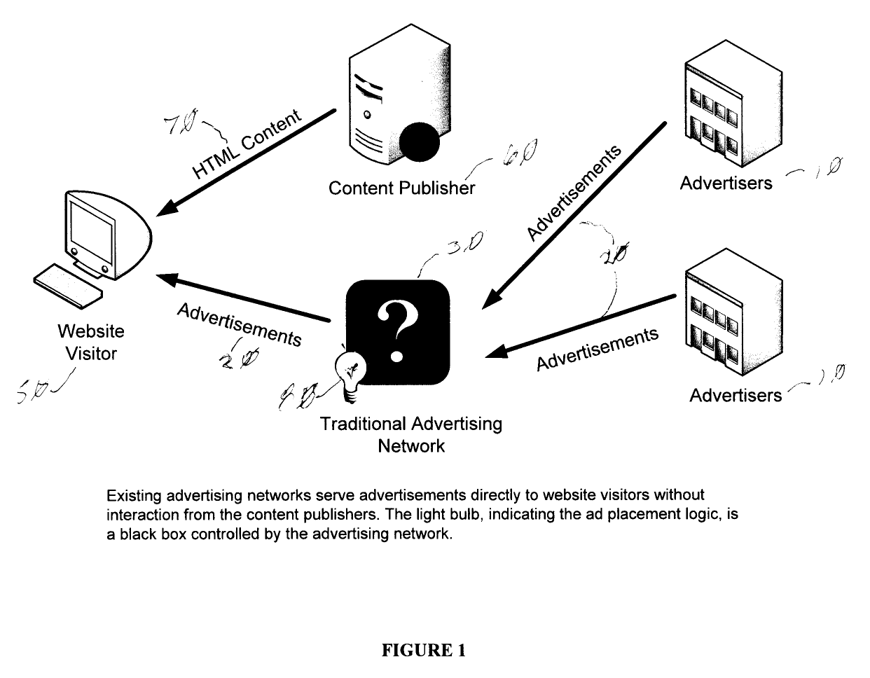

With reference to the figures in which like numerals represent like elements throughout, FIG. 1 is a depiction of the typical prior art web advertisement placement and pricing system. In the prior art advertising network, advertisers 10 provide advertisements 20 to the advertising network 30. The advertising network 30 then serves the advertisements 20 directly to web site users, or visitors, 50 without interaction from the content publishers 60. The advertisement 20 is not provided by the publisher 60 inline with the other HTML content 70 of the publishers' web site, but rather is supplied by some external advertisement server. In FIG. 1, the light bulb 80, indicating the ad placement logic 80, is a black box controlled by the advertising network 30.

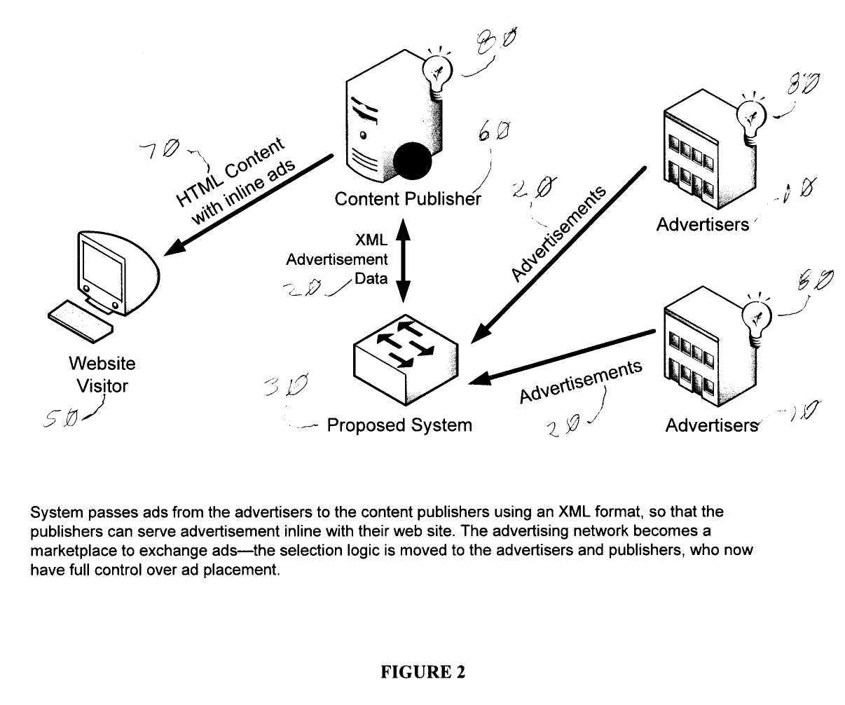

In contrast to the prior art systems, FIG. 2 presents an overview of a first embodiment of the advertising network of the present invention. The invention uses the standard CPC pricing model, where advertisers bid a price per click when placing an ad. However, rather than the advertising network 30 using these bids to select ad placement, the advertising network 30 will deliver a collection of advertisements 20 from various advertisers 10 along with their bid prices and other statistics to a content publisher 60, who will select and display the advertisements inline with the HTML content 70 of the publishers website. The system passes ads 20 from the advertisers 10 to the content publishers 60 using an XML format, so that the publishers 60 can inline the ads into their web site. Stated another way, the ad content of the advertisement 20 is embedded within the HTML content of the publishers' 80 web site for a seamless display. The advertising network 30 becomes a marketplace to exchange ads and the selection logic 80, depicted by the light bulbs, is moved to the advertisers 10 and publishers 20, who now have full control over ad placement. Thus, the ads no longer rely on JavaScript running on the visitor's 50 web browser.

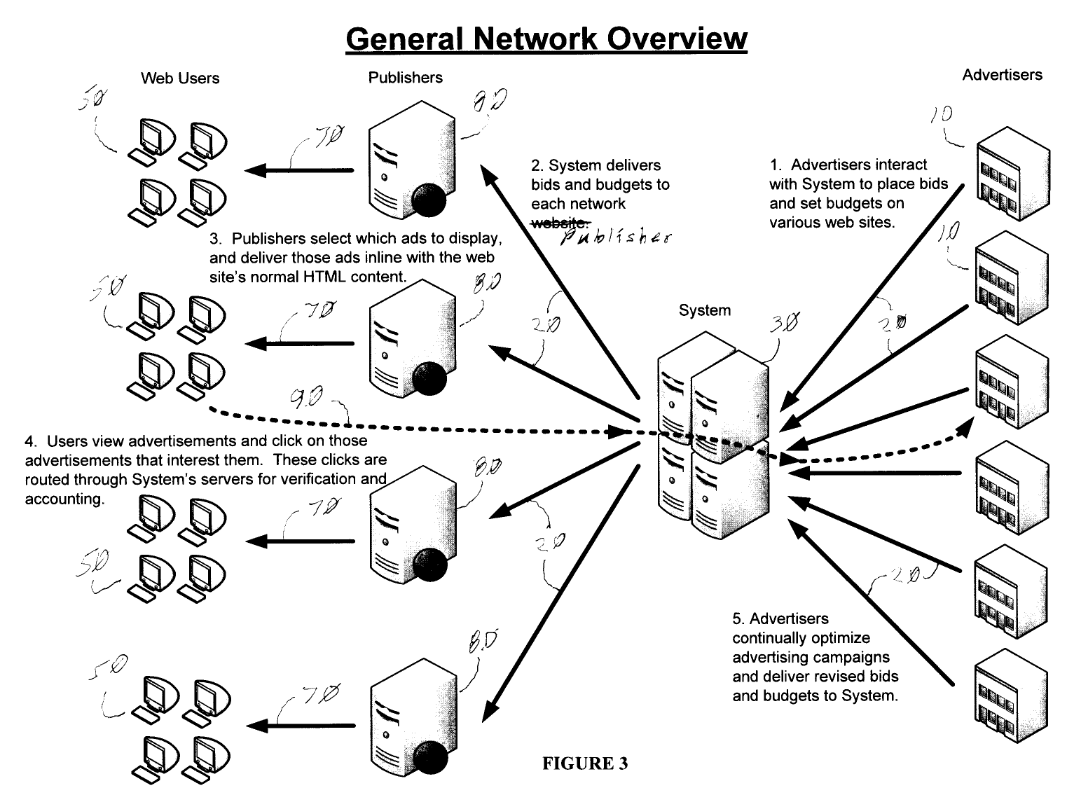

FIG. 3 presents a further overview of the network of the current invention. First, advertisers interact with the system to place bids and set budgets on various websites. The system then delivers these bids and budgets to each network publisher. The publishers 80 select the ads 20 to display and deliver those ads inline with the web site's normal HTML content 70. Users 50 view the advertisements 20 included in the HTML content 70 and click on those ads that interest them. These clicks, or user selections, are routed through the systems servers for verification and accounting. The user selections are shown pictorially by dashed arrow 90. The user selections 90 are then routed to the advertiser 10 websites by the system 30.

An important aspect of the system is the pricing of ads. With this system of the current invention, advertisements 20 are bought and sold in an auction style. Advertisers 10 attach a price per click to each of their ads 20. The higher the bid, the more impressions their ads are likely to receive. The advertisers 10 have fine-grained control of the bidding process and can target their ads to certain web sites, or categories of web sites, by offering a higher price per click. For example, a car manufacturer may be willing to pay 50 cents per click from automotive sites, but only 20 cents per click from all other sites. The advertisers 10 may also set a budget for each advertisement which is not to be exceeded within the system.

The advertising network 30 forwards these offers to the content publishers 80 via an XML file. Typically, an advertising network would take a percentage of the price, current advertising networks collect approximately 15-50% of the cost of the click. Since the publishers 80 has full knowledge and control of the ads 20 shown on their sites, they can collect statistics on the click-through ratio of advertisements 20 and choose to show the most profitable ads. A Click-Through Ratio (“CTR”) is the ratio how many times a visitor clicks on an ad, out of how many times the ad was shown. A publisher 80 would want to maximize their revenue per impression the product of the cost per click offer from the advertiser 10 and the click-through ratio of the advertisement. Thus, a publisher 80 can collect data and determine the local optimum for advertising on their site.

Furthermore, an advertiser can collect data to maximize the profitability of their ad campaign. For instance, if statistics show that user traffic coming from one web site is twice as likely to make a purchase as compared to visitors coming from other web sites, the advertiser can raise their cost per click bid on the more profitable site and lower their bid on the others. By increasing their bid price, they will gain additional advertising on the profitable site, and maximize the profitability of their advertising campaign.

The system and method of the present invention offers numerous potential benefits over existing Internet advertising networks:

The invention provides better targeting of advertisements. The content publisher has access to the pages a user has viewed, order history, and keywords they have been typed. The advertising networks do not have access to as much data. Thus, the content publishers, and the system as a whole, may better target advertisements to users.

The invention also provides a faster web browsing experience. Web sites currently appear slower to visitors due to the loading of advertisements. With this system, ads will be fully integrated into the web site, eliminating the loading time.

The invention further provides more flexibility for the content publishers. A web site is no longer forced to show an unprofitable ad. Publishers can track revenue earned from each advertisement, and select ones that are the most profitable.

The invention further provides fine-grained ad placement for advertisers. Advertisers can place unique bids for each publisher in the ad network, allowing them to choose ad placement based on historical performance.

The invention further provides better integration of the advertisement into the publisher web site. For text ads, the content publisher can select colors, fonts, and layouts that flow with the design of the web site, resulting in more ads being viewed by visitors.

The invention further provides prevention of dismissal or blocking of the ad by ad blocking software. By serving advertisements from the content publisher's web server, instead of the advertising network's servers, ads become part of the publishers' web site content, and cannot be easily blocked by existing techniques.

In another embodiment of the present invention, the system software includes four main components:

SQL Database—A SQL database maintains account information, records bids, and stores click logs. For the system prototype, MySQL 4 was used.

Matrices—In order to maintain a record of every bid currently in the system, and provide adequate advertising budget throttling, the system maintains two matrices: a bidding matrix and a throttling matrix. The bidding and throttling matrices will be discussed below.

Server-side scripts—The server-side scripts operate on the system web and application servers and provide a web interface for the advertisers and publishers to manage their accounts. They also implement the back-end accounting and throttling logic.

Client-side script—Each content publisher runs a script on their server, which downloads ads via an XML file on the system server and rotates ads on the publisher's site. While content publishers are free to use any ad selection code they choose, a feedback loop may be used to maximize profit.

In delivering ads from the advertising network to the content publishers, there were two important considerations: First, the protocol must be completely pull-based. Many content publishers will keep their web servers behind a firewall, and will not want to open an inbound port for the advertising network. Second, the protocol must be simple, and portable. Content publishers use a variety of hardware and scripting languages to serve their web content, thus the client-side advertising code must be portable to any system.

To satisfy these two goals in another embodiment of the present invention, ads are delivered to the content publishers by serving an Extensible Markup Language (“XML”) file over HTTP. XML and HTTP are both simple, standard protocols that are already supported by nearly every scripting language. As will be appreciated by those skilled in the art, other programming languages may be used.

It is also necessary to implement some form of authentication and security for the ad delivery protocol. An advertiser's bid to a publisher is confidential information that neither party would necessarily want viewable by their competitors. Thus, for the initial system prototype, an 8-digit PIN number, similar to the PIN number on a bank account, is passed in the query string of the HTTP request. In other production embodiments of the present invention, additional security measures such as SSL encryption, stronger authentication, and IP-based filters may be added to the system as known to those skilled in the art.

In another embodiment of the invention, the contents of a sample XML file are:

<ads expiration=“2007-12-31 16:00:00 GMT”>

<ad id=“1234”>

<title>A Sample Advertisement</title>
<text>A short description of the link goes here.</text>
<url>http://www.thesystem.com/ads/redirect.php?ad=123&ref=456</url>
<bid>30</bid>
<maxclicks>27</maxclicks>

</ad>

</ads>

The first tag in the XML file contains an expiration date. This is critical, since the ad delivery system is completely pull-based. The expiration date on the XML data is the advertising network's means of removing advertisements from the system once they have exhausted their budget, or have been removed by the advertiser. The XML files are updated on an hourly basis. Thus, the expiration date is set to the beginning of the next hour.

As presented above each ad contains a unique id value. This value can be used by the client-side ad serving code, in order to track an ad's performance. Thus, id values may never be re-used. In addition, if the content of the ad is changed, the ad must be assigned a new id.

The title, text, and url fields of the XML file contain the actual advertisement. Note that the url field does not contain the final target URL. Instead, it points to a redirect script on the advertising network's web site. This is done so that the advertising network can track clicks and perform accounting.

The bid field contains the bid from the advertiser to this content publisher. For simplicity, commissions are subtracted from the bid before it is received by the publisher. For example, if the commission is 20%, a 50 cent bid would show up as 40 cents in the publisher's XML file.

Finally, there is a max-clicks field, which tells the publisher how many times they can receive payment for clicks during the current period. The purpose of max-clicks is to limit the number of clicks an ad receives, so that the advertiser can stay within their desired budget. Formulas for max-clicks throttling is discussed later.

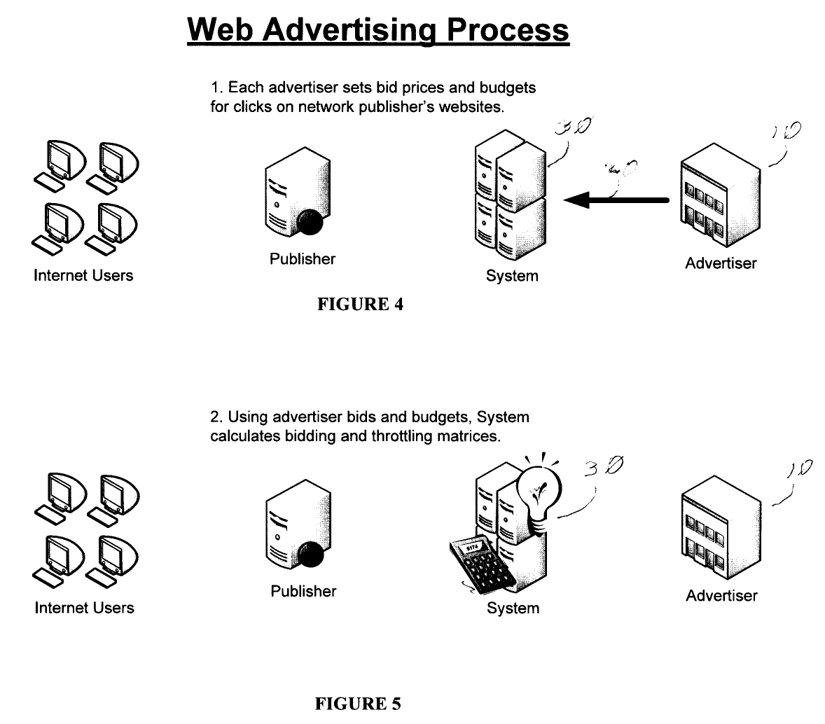

Another embodiment of the web advertising system and method of the present invention is depicted in FIGS. 4-8. As shown in FIG. 4, each advertiser 10 selects bid prices and budgets for clicks on network publishers' websites 30. The advertisements supplied to the system 30 include bid prices and budgets, and the ad content, and are depicted by arrow 20. The ad supplied by the advertiser will also contain the actual ad content, which includes the destination advertiser web site and the ad creative content. The creative content may be text, image, rich media, or other content as is readily known to those skilled in the art.

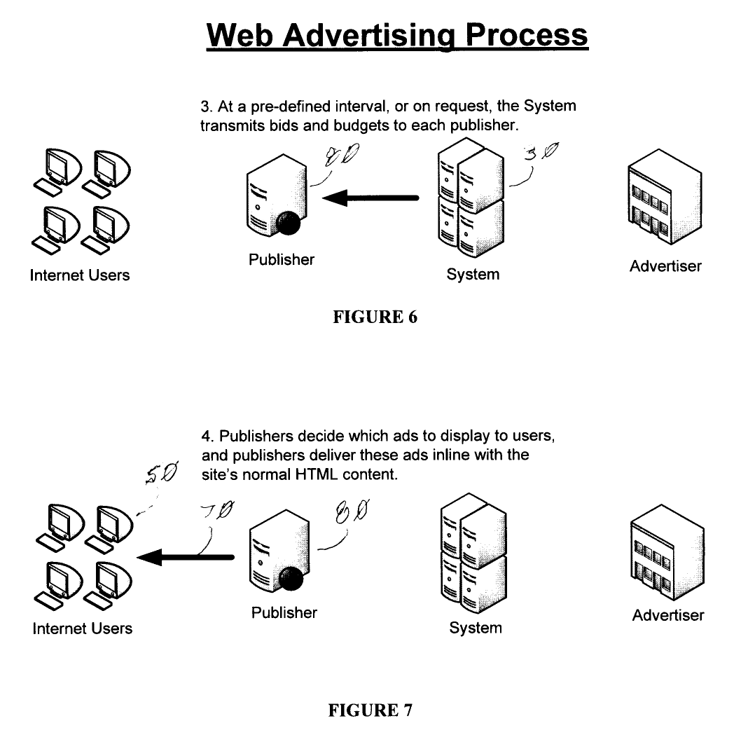

As shown in FIG. 5, the system servers and software of the present invention receive the advertiser ad content, bids and budgets. The system then calculates a bidding matrices and throttling matrices for all advertisements within the system. As shown in FIG. 6, at pre-defined intervals, or on request of a publisher 80, the system transmits the ad contents, and relevant bids, and budgets to each publisher 80. The bids and budgets are transferred via portion of the bidding and throttling matrices calculated in FIG. 5 above. The publisher only receives those portions of the bidding and throttling matrices which bid on one of the publishers websites.

As shown in FIG. 7, the publishers 80 review the ads, and the bidding and throttling matrices received. The publishers 80 then decide which ads to display to users 50. The publishers 80 then deliver the ads inline with the web sites normal HTML content. The delivery of the HTML content including the ad is depicted by arrow 70.

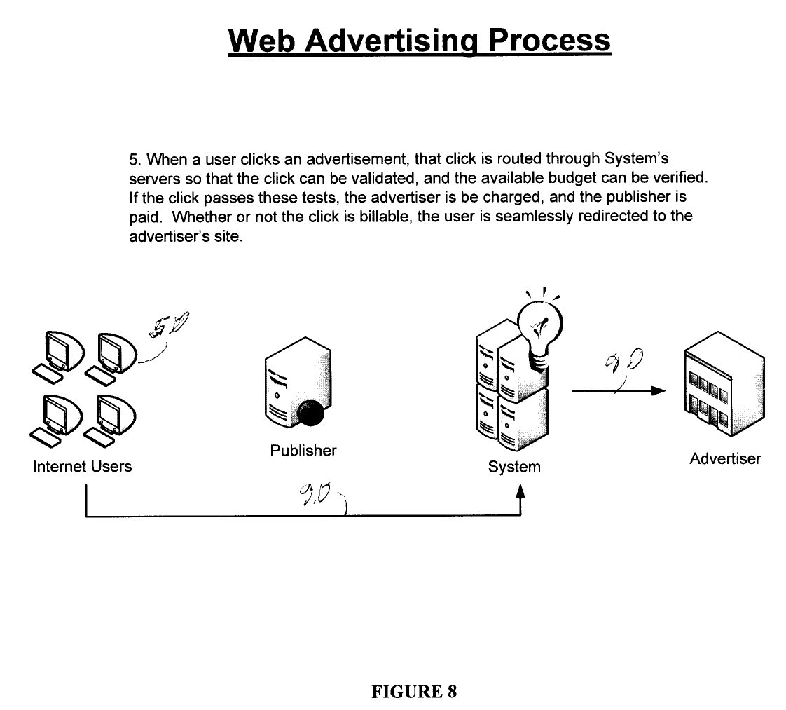

As shown in FIG. 8, when a user clicks an advertisement, the click, or user selection, is routed through the system servers 30 so the click may be validated, and the available ad budget can be verified. The user selection is depicted by arrows 90. If the user selection passes the validation tests, the advertiser is charged, and the publisher is paid. The user selection is then redirected to the advertisers web site associated with the ad.

An open advertising network such as the system gives advertisers the opportunity to offer a different price per click to every single site in the advertising network. However, in a network with thousands of content publishers, managing thousands of bids can become too complex. Thus, to simplify the management of bids, without losing flexibility, in another embodiment of the present invention, there are three different types of bids which an advertiser may place:

Site Bid—A site bid is a bid placed for one individual site. An advertiser may place a site bid for each site in the system, if they choose.

Category Bid—All content publishers are assigned to a category when they join the advertising network. An advertiser may choose to place a bid for an entire category of web sites. Category bids are overridden by any site bids.

Default Bid—A default bid is a bid offered to all sites in the system. Default bids can be overridden by both site and category bids.

Note that it is possible to place a bid of zero for any of the three types, which prevents an ad from being shown on a site. Thus, an advertiser can offer a bid of 10 cents per click to all sites in the network except for one, by placing a default bid of 10 cents and a site bid of 0 for the exception. In addition, category and default bids offer advertisers a means for bidding on new sites as they enter the advertising network. If the site proves to be highly effective, or ineffective, the advertiser can later adjust their bid using a site bid.

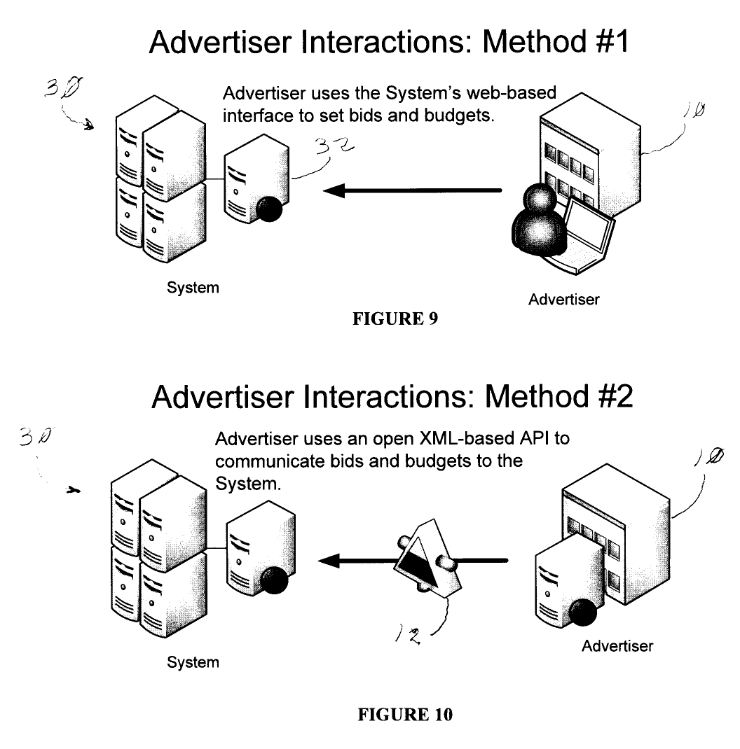

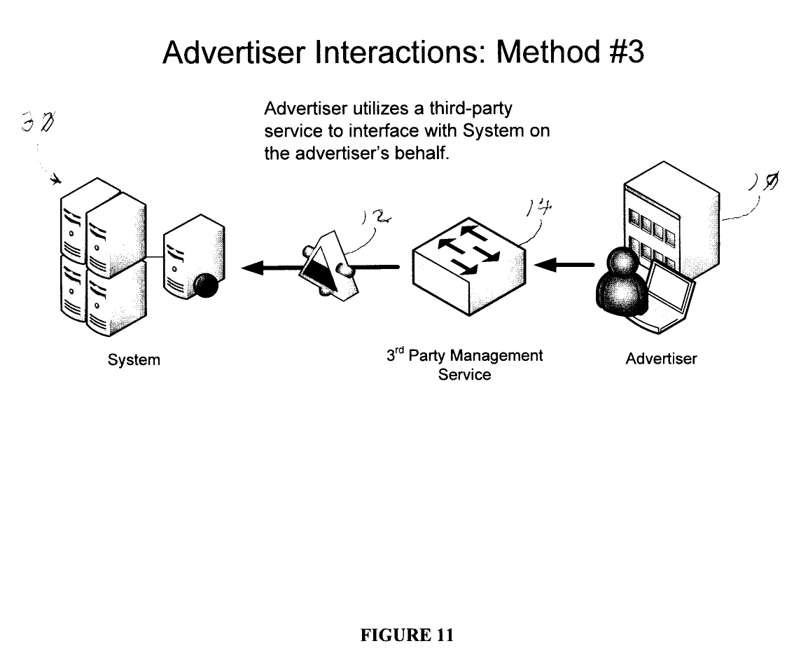

In other alternative embodiments of the present invention, the advertisers may interact with the system in a variety of methods, as depicted in FIGS. 9-11. In FIG. 9, the advertiser 10 uses the systems 30 web based interface, via web server 32, to set bids and budgets, and transfer ad content. In FIG. 10, the advertiser 10 uses an XML based application 12 to communicate ad content, bids and budgets to the system 30. In FIG. 11, the advertiser 10 uses a third party service 14 to interface with the system on the advertisers 10 behalf. The third party service 14 may also use an XML based application 12 to communicate with the system 30.

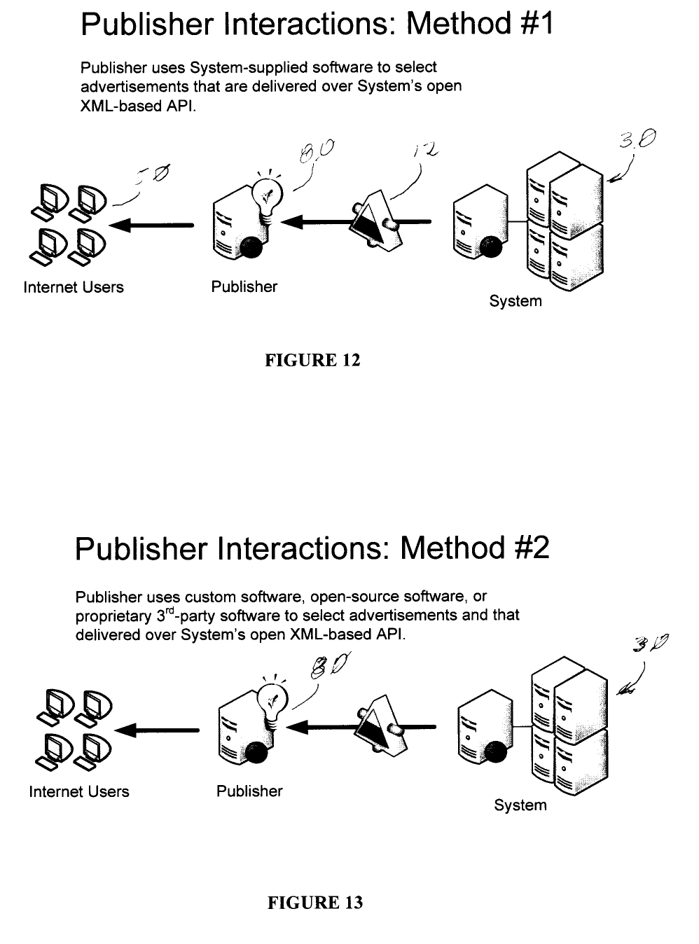

In other alternative embodiments of the present invention, the publishers may interact with the system in a variety of methods, as depicted in FIGS. 12-15. In FIG. 12, a publisher 80 uses system supplied software to select advertisements. The ads are then delivered to the publisher 80 using the systems 30 XML based application programming interface (“API”) 12. In FIG. 13, the publisher 80 uses custom software, open-source software, or proprietary 3^{rd} party software to select advertisements. The advertisements are then delivered to the publisher over the system 30 XML API.

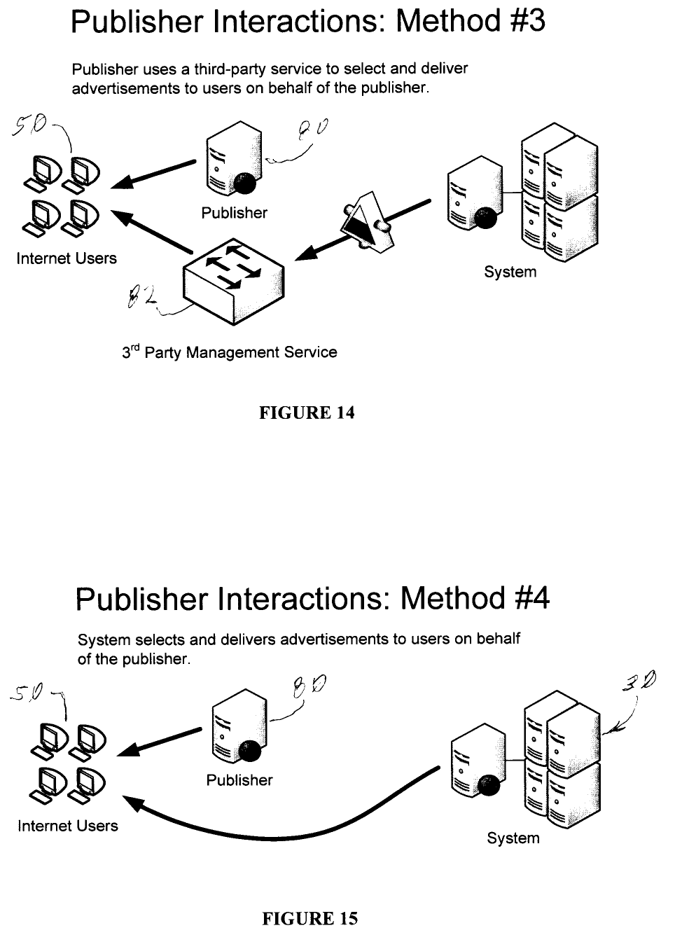

In FIG. 14, the publisher 80 uses a third party service 82 to select and deliver advertisements to directly to web users 50 on behalf of the publisher 80. In FIG. 15, the system 30 selects and delivers advertisements directly to the web user 50 on behalf of the publisher 80.

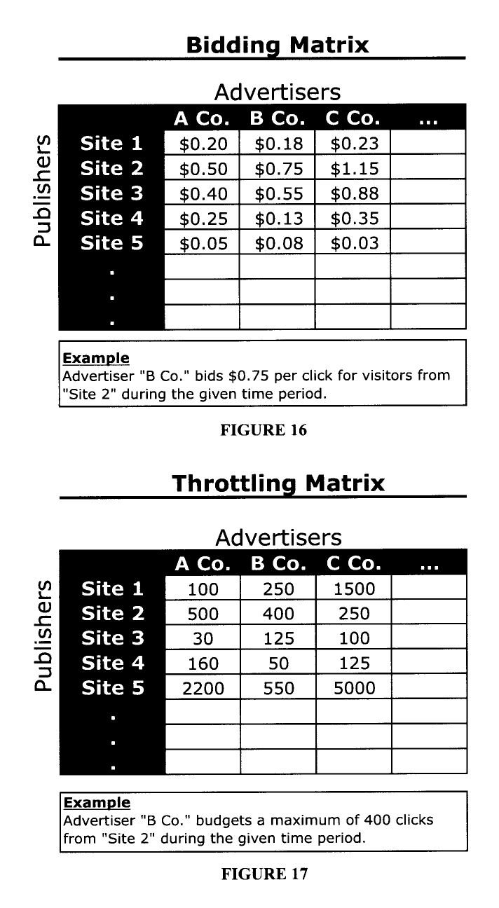

While category and default bids offer ease of management for the advertisers, all bids must be converted to a flat matrix so that bids may be delivered to the content publishers. This matrix is referred to as a bidding matrix and an example is presented in FIG. 16. The advertiser bids are placed into an n-by-m matrix, where n is the number of web sites and m is the number of advertisements. The bid for site i from advertisement j is referred to as Bi,j. A single advertiser may have multiple ads within the matrix, and a single publisher may appear in the table multiple times as they may represent more than one web site. In one embodiment of the present invention, the bid matrix, and the throttling matrix, discussed below, are stored in a SQL table with the site and advertisement as primary key.

The system and method of the present invention uses throttling to give advertisers a means of limiting their advertising expense. Thus, the system allows advertisers to provide a target daily budget Dj for each advertisement j. Using this value, some maximum number of clicks (Mi,j) is allocated for each site/advertisement pair, and tracked in a throttling matrix. An example throttling matrix is presented in FIG. 17. The calculated maximum number of clicks are placed into an n-by-m matrix, where n is the number of web sites and m is the number of advertisements. Every time an ad is clicked, the Mi,j entry is decremented by one, and once an entry reaches zero, the site i will no longer receive payment for clicks to ad j, and similarly, advertiser j's account will not be debited.

The throttling matrix is recalculated at the end of each expiration period using the formula below:

Mi;j=(Dj/p)·[(Bi;j·Cj)/Σsites(Bs;j·Cs)]·(1/Bi;j)·min(Lj/Dj,o)
where:
p=expiration periods remaining in the current day
o=maximum oversell ratio
Ci=historical clicks per day for site i
Dj=daily budget remaining for advertisement j
Lj=account balance of advertiser j
Bi;j=bid for site i from advertisement j
Mi;j=maximum clicks offered to site i to show ad j during the upcoming expiration period

As seen above, the throttling matrix formula consists of four terms. The first term, Dj/p, takes the advertisement's daily budget, and divides it by the number of periods remaining in the day. This yields the budget for the upcoming period.

The second term takes the advertiser's budget and divides it amongst all sites, in proportion to the bid times clicks. Initially, bid alone was selected, because a higher bid indicates that an advertiser wishes to receive more traffic from a particular site. However, since various content publishers have very different amounts of traffic, sites with more traffic need to be allocated more clicks than lower-traffic sites. Thus, in one embodiment of the invention, the system uses its historical click logs to track the average number of clicks per day for each site (Ci). Ci must be bounded by some non-zero value, otherwise sites first entering the network will have a Ci of zero and never receive any ads. In a prototype implementation of the invention it has been found that limiting Ci to a minimum value of 20 works well. Hence, bid times clicks are used to allocate an advertiser's budget between sites.

The third term of the equation above takes the budget allocated for a site/advertisement pair and divides it by the bid to get clicks.

The fourth term addresses the need of ads to be oversold. One of the key points of an open advertising network is that content publishers have the ability to not show particular ads, thus the advertising network must offer sites more ads than they can possibly serve, giving them choices. Thus, all ads in the system are oversold by some constant o. In a prototype implementation of the invention, a value of 5 was selected for o—however, this value can be adjusted to make the throttling more conservative or aggressive.

To prevent advertisers from exceeding the funds available (Lj) in their account, the overselling term is limited to Lj=Dj. As an advertiser's funds get low, Lj=Dj becomes less than o. The Dj in the denominator cancels with the Dj in the first term, thus the advertisement is never oversold by more than the advertiser can afford.

In another embodiment of the present invention, a client-side script was developed for the content publishers to use to fetch ads from the system, evaluate the performance of ads, and select ads for display. In this embodiment, the client uses a simple feedback loop to maximize revenue for the content publisher.

Since the client code selects and displays ads, it is able to keep a count of impressions and clicks for each ad. This is implemented using a SQL database containing an advertisements table. This table contains all of the fields in the XML file, plus fields to track impressions and clicks. Note that the publisher must track not only ads in the current XML file, but all ads which have recently appeared. It is possible for an advertisement to temporarily disappear from the XML listings, if the advertiser's account balance gets too low, or if the advertiser places a bid of zero for the content publisher.

In another embodiment of the present invention, in order to effectively select ads for display, the publisher gives each ad a “trial period” of 1,000 initial impressions which are used to calculate a CTR for each ad. Once ads have completed their trial period, ads are selected based upon maximizing estimated revenue using the formula:

revenue=(clicks·bid)/impressions±r

where r is a small random variable, used to create some variety in the selection of ads. This addresses the problem of linear programming solutions causing non-optimal ad placement.

The clicks and impressions values are continually tracked, both during and after the ad's trial period, thus it is possible for the optimal ads to change over time, even if no ads are added or removed from the system. In addition, advertisers can change their bid at any time, which directly affects whether their ads are displayed under this selection algorithm. In a prototype implementation of the invention, the default settings for the client display five ads, three of which are based upon maximizing revenue, the other two randomly selected from the ads in their trial period.

While this section describes a simple implementation of an advertising client, which was written in PHP in under 350 lines of code, in an open network, content publishers are free to develop their own ad selection algorithms. As will be appreciated by those skilled in the art, algorithms may use category- or keyword-targeting, or may track CTRs on a per-visitor basis. In addition, since the communication protocol between the system and the clients uses simple XML over HTTP, it is possible for third parties to create managed advertisement selection and hosting services.

In another embodiment of the present invention, when a visitor clicks on a system ad, the visitor's browser follows a series of HTTP redirects before reaching the advertiser's site. This is a common practice in Internet advertising, and allows for the advertising network to properly account for clicks. The advertisement itself links to some URL on the content publisher's server. This script allows the advertising client to perform its accounting and tracking the CTR of ads so that it may effectively target. The publisher/client then responds with an HTTP redirect to the URL provided in the XML file. The XML file contains a link to the system. The URL passes the advertisement ID and referring site in the query string. Thus, the system can debit and credit the advertiser's and publisher's accounts, respectively. Then, the user is redirected to the final advertiser's URL.

In a prototype installation of the system and method, some mechanisms to prevent click fraud were found to be needed. In the installation, web crawlers, particularly those of the major search engines, crawled many of the advertisements, thus creating false user selections. In addition, there were numerous duplicate clicks from the same IP address. Unlike clicks from multiple users behind a firewall, which would be one explanation for clicks coming from the same IP, the traffic from these clicks were extremely bursty, with clicks appearing within seconds of each other. This may have been the result of the same user clicking an ad twice, because a server was slow to respond, or possibly a badly-behaved web crawler which did not identify itself in its User-Agent string. In this embodiment of the invention, three techniques were found useful to prevent click fraud:

robots.txt—The first line of defense is eliminating the well-behaved crawlers and robots. This was done by placing a robots.txt file on the system web site to prevent bots and crawlers from accessing the redirect script.

User-Agent Filter—Since some robots do not properly obey robots.txt files, the redirect script checks the User-Agent field of the HTTP request. If the field contains the words “bot,” “crawl,” or “spider,” then the click is not counted.

IP Address Filter—Finally, clicks from the same IP address are filtered by checking the click logs. Any click to the same ad from the same site and visitor IP address within an hour period is not counted.

In another alternative embodiment of the present invention, geo-targeting is used in the ad placements. Advertisers will benefit from the ability to target their ads by the location of the visitor. As known to those skilled in the art, many databases are available, which map IP addresses to countries and regions, and existing advertising networks use this data to select the ads which are shown.

In one geo-targeting embodiment, the system may allow advertisers to place a separate bid for each geographic region. In this embodiment, the scalability of the system architecture suffers. The bid matrices and throttling matrices can become 3-dimensional, and the update algorithm would take O(n3) time. Plus, the size of the XML file would square, placing much more load on the content publishers.

In an alternative geo-targeting embodiment, advertisers include a list of regions when they create an advertisement. This embodiment provides geo-targeting within the system with reasonable scalability. The IP to region database would be distributed to all publishers. Then, when a publisher receives a visitor, the client would determine the visitor's region based upon their IP address. Then, the ad selection algorithm would select from the ads with matching regions. The advertising network's click redirection code would perform the same check before performing payment for the click, in order to make sure that the publishers implement geo-targeting.

The system allows content publishers to fully automate their optimization process, by using the client script to select ads based upon their historical performance. Many online businesses now use sophisticated software to track sales and performance. In another alternative embodiment of the present invention, the system automates the feedback of sales and performance data to control the ad bids of the advertising parties.

An advertiser API is implemented in a fashion similar to the publisher API. The advertiser provides bids via an XML file, generated from their visitor-tracking software. This allows advertisers to bid for visitors based upon the metric of their choice, for example, pages viewed or dollars spent, depending on the advertiser's business model. The advertising network then downloads this XML file before each matrix update, using the advertiser's most recent bids to perform the update.

In a prior embodiment of the invention, one simple implementation of an ad selection algorithm for content publishers was presented. While simple and effective, the ad selection algorithm may be improved. In particular, the use of a trial period (offering each ad a minimum of 1,000 impressions) makes the advertising network vulnerable to spamming. Under the prior embodiment, it would be possible for an advertiser to offer minimal bids, yet receive a large number of impressions by regularly deleting and recreating their advertisements to exploit the trial periods of the content publishers.

In another alternative embodiment, the client algorithm is modified to consider not just the advertisement's performance, but also the performance of the advertiser. The trial period given to each ad could depend on the historical CTR of the advertiser. This is easily accomplished by adding a field to the XML format to provide the advertiser's account ID or domain name. In addition, in the present system content publishers are free to share information between each other. Thus, it is possible to create repositories of advertiser reviews, where publishers share feedback about advertisers. Like the blacklists currently used to prevent e-mail spam, advertisers who spam the network would be identified and blacklisted by publishers.

While there has been shown a preferred embodiment of the present invention, it is to be understood that certain changes may be made in the form and arrangement of the system elements and steps for the method for the optimization of the web advertising process without departing from the underlying spirit and scope of the invention.

What is claimed is:

1. A web advertising system, configured to provide an online advertisement data exchange between advertisers, publishers, and web users, the web advertising system comprising:
a web server configured to provide a user interface to advertisers and publishers accessing the online advertisement information exchange;
one or more application servers, in communication with the web server, and configured to manage data objects associated with the respective advertisers and publishers;
a database in communication with the one or more application servers, the database storing data including the data objects;
wherein the data objects comprise a plurality of advertiser accounts, a plurality of publisher accounts, a plurality of ads supplied by the plurality of advertisers, each ad comprising at least one ad bid, at least one publisher website, and an ad budget;
the application servers configured to periodically calculate a bidding matrix and a throttling matrix for the plurality of ads and publishers;
the web server further configured to allow a publisher to periodically access and download the plurality of ads, a portion of the bidding matrix relative to the publisher, and a portion of the throttling matrix relative to the publisher;
the application servers further configured to receive a web user selection of a particular ad from a publisher website, storing the data regarding the user selection, the associated ad, and the associated publisher website, and redirecting the user to an advertiser website associated with the relevant advertiser and ad.

2. The web advertising system of claim 1, wherein the application servers are configured to use the data regarding the user selection, the ad, and the publisher to:
access the data comprising the ad budget, the bidding matrix relative to the publisher, and the throttling matrix relative to the publisher;
verify the ad bid corresponding to the ad and publisher within the bidding matrix;
verify the availability for user selection corresponding to the ad and publisher within the throttling matrix; and
store a verification result.

3. The web advertising system of claim 2, wherein the stored verification results are used in the next periodic calculation of the throttling matrix.

4. The web advertising system of claim 2, wherein based upon the verification results, the ad bid is subtracted from the ad budget of the advertisers account.

5. The web advertising system of claim 2, wherein based upon the verification results, the publishers account is credited with the ad bid.

6. The web advertising system of claim 2, further comprising an accounting package in communication with the database, the accounting package configured to manage billing among the advertisers and payment among the publishers.

7. The web advertising system of claim 1, wherein the web server is configured to allow a publisher to periodically accesses and downloads the plurality of ads, a portion of the bidding matrix relative to the publisher, and a portion of the throttling matrix relative to the publisher, the publisher then:
evaluating the profitability of each potential ad using the ad bid, and an estimate of the rate of user selections;
selecting a subset of the plurality of ads for display on the publishers websites;
publishing the selected ads on the publishers websites.

8. The web advertising system of claim 7, wherein the publisher serves the selected ads inline with other content on the publishers website.

9. The web advertising system of claim 7, wherein the estimate of the rate of user selections is based on at least one of:
a trial estimate;
the prior display of the same ad;
the prior display of similar ads; or
the prior display of ads from the same advertiser.

10. The web advertising system of claim 1, wherein each ad supplied by an advertiser comprises at least one of:
a default ad bid for all publisher websites;
a unique ad bid for each publisher website;
a unique ad bid for each advertising category of websites; or
an ad bid of 0 for a publisher website.

11. The web advertising system of claim 1, wherein the web server is configured to allow an advertiser to periodically accesses and download the data associated with the advertiser account regarding the user selections, the associated ad, and the associated publisher website, the advertiser then;
evaluating the effectiveness of each ad, using the ad bid, the rate of user selections, and the rate of sales generated per user selection;
updating the ad bids for each publisher website, and the ad budget; and
uploading to the web server the updated ad bids for each publisher website, and the ad budget.

12. The web advertising system of claim 11, wherein the updated ad bids for each publisher are used in the next periodic calculation of the throttling matrix.

13. The web advertising system of claim 1, wherein the application servers calculate the bidding matrix, and the throttling matrix, for the plurality of ads and publishers within the system at periodic intervals.

14. A method of enabling and optimizing web advertisement placement and pricing, the method comprising:
receiving on a web server a plurality of advertiser accounts, a plurality of ads supplied by the plurality of advertisers, each ad comprising at least one ad bid, at least one publisher website, and an ad budget, and a plurality of publisher accounts;
storing the plurality of advertiser accounts, advertisements, and publisher accounts in a database;
periodically calculating on an application server a bidding matrix and a throttling matrix for the plurality of ads and publishers, the application server, web server, and database being interconnected;
a publisher periodically accessing and downloading the plurality of ads, a portion of the bidding matrix relative to the publisher, and a portion of the throttling matrix relative to the publisher;
the application servers receiving a web user selection of a particular ad from a publisher website, the servers storing the data regarding the user selection, the associated ad, and the associated publisher website in the database; and
redirecting the user to an advertiser website associated with the relevant advertiser and ad.

15. The method of claim 14, wherein using the data regarding the user selection, the associated ad, and the associated publisher the system:
accesses the data comprising the ad budget, the bidding matrix relative to the publisher, and the throttling matrix relative to the publisher;
verifies the ad bid corresponding to the ad and publisher within the bidding matrix;
verifies the availability for user selection corresponding to the ad and publisher within the throttling matrix;
stores a verification result in the database.

16. The method of claim 14, wherein using wherein a publisher periodically accesses and downloads the plurality of ads, a portion of the bidding matrix relative to the publisher, and a portion of the throttling matrix relative to the publisher from the web server, the publisher then:
evaluates the profitability of each potential ad using the ad bid, and an estimate of the rate of user selections;
selects a subset of the plurality of ads for display on the publishers websites;
publishes the selected ads on the publishers websites.

17. The method of claim 16, wherein the publisher serves the selected ads inline with other content on the publishers' website.

18. The method of claim 16, wherein the estimate of the rate of user selections is based on at least one of:
a trial estimate;
the prior display of the same ad;
the prior display of similar ads; or
the prior display of ads from the same advertiser.

19. The method of claim 14, wherein an advertiser periodically accesses and downloads the data associated with the advertiser's account regarding the user selections, the associated ad, and the associated publisher website from the web server, the advertiser then;
evaluates the effectiveness of each ad, using the ad bid, the rate of user selections, and the rate of sales generated per user selection;
updates the ad bids for each publisher website, and the ad budget; and
uploads to the web server the updated ad bids for each publisher website, and the updated ad budget.

20. The method of claim 14, wherein the updated ad bids for each publisher are used in the next periodic calculation of the throttling matrix.
